(19) United States
(12) Patent Application Publication
(10) Pub. No.: US 2008/0255215 A1
(43) Pub. Date: Oct. 16, 2008

(54) Combinations of Alkylalkanolamines and Alkylbisalkanolamines for Antimicrobial Compositions

(76) Inventors: Michael D. Gernon, Phoenixville, PA (US); Conor M. Dowling, Ambler, PA (US)

Correspondence Address: SUGHRUE MION, PLLC, 2100 PENNSYLVANIA AVENUE, N.W., SUITE 800, WASHINGTON, DC, 20037, US

(21) Appl. No.: 12/066,691

(22) PCT Filed: Aug. 31, 2006
(86) PCT No.: PCT/US06/33979

§ 371 Date: Mar. 13, 2008

Related U.S. Application Data
(60) Provisional application No. 60/716,428, filed on Sep. 13, 2005.

(51) Int. Cl. A01N 43/80; A01N 25/00

(52) U.S. Cl. 514/372; 514/788

(57) ABSTRACT

An antimicrobial composition includes an effective amount of a biocide, and a biocide enhancer consisting of one or more compounds according to formula (I) and one or more compounds according to formula (II):

R¹—NH—CH₂CHR³OH (I)

R²—NH(CH₂CHR⁴OH)₂ (II)

wherein R¹ and R² are each individually selected from the group consisting of branched and linear C4 to C16 alkyl groups and wherein R³ and R⁴ are each individually H or methyl. Compositions incorporating these antimicrobial formulations may include treated fluids, for example organic fluids or mixtures of organic fluids and aqueous fluids. Such treated compositions may be used for metalworking or for any of a number of other applications.

### FIELD OF THE INVENTION

The invention relates to antimicrobial compositions. More particularly, it relates to antimicrobial compositions incorporating mixtures of alkylalkanolamines, alkylbisalkanolamines, and biocides.

### BACKGROUND OF THE INVENTION

One of the problems often associated with many types of industrial fluids, especially those containing water, is the susceptibility of the fluid to the infestation and growth of various microorganisms such as bacteria and fungi which feed on the organic components of the fluid. The presence and buildup of such microorganisms can often lead to interference of mechanical operations as a result of the clogging of filters, buildup of slime and sludge, development of odors, rust, emulsion instability, reduced tool life and poor finish. Furthermore, where the workers' hands necessarily come in contact with these deteriorated fluids, serious problems of dermatitis may arise. As a result of these problems, antimicrobial compositions are commonly added to various kinds of industrial fluids to reduce or inhibit the growth of microorganisms. In particular, a wide variety of industrial water based fluids such as metalworking fluids, latex paints, and water based hydraulic fluids require antimicrobial compositions to control the growth microorganisms which eventually render the fluids rancid. Thus, there is a continuing search for better antimicrobial additives for industrial fluids, especially those fluids containing water.

### SUMMARY OF THE INVENTION

In one aspect, the invention provides a composition including an effective amount of a biocide and a biocide enhancer. The biocide enhancer consists of one or more compounds according to formula (I) and one or more compounds according to formula (II):

R¹—NH—CH₂CHR³OH (I)

R²—NH(CH₂CHR⁴OH)₂ (II)

wherein R¹ and R² are each individually selected from the group consisting of branched and linear C4 to C16 alkyl groups and wherein R³ and R⁴ are each individually H or methyl.

In another aspect, the invention provides a method of inhibiting or preventing biological growth in a composition. The method includes adding to the composition an effective amount of a biocide and a biocide enhancer as defined immediately above.

### BRIEF DESCRIPTION OF THE DRAWINGS

FIG. 1 shows results of biological assay experiments comparing prior art antimicrobial compositions with compositions according to the invention.

### DETAILED DESCRIPTION OF THE INVENTION

This invention provides highly effective antimicrobial compositions that employ certain combinations of alkylalkanolamines and alkylbisalkanolamines in the presence of a biocide, thereby increasing the biocide's effectiveness. The compositions may be used in any of a number of applications, without limitation. One particularly useful application may be in any of a variety of industrial fluids where biological growth is to be discouraged. In some nonlimiting embodiments of the invention, the fluids may be essentially pure organic liquids containing traces of water, solutions of organic liquids with water, “water in oil” emulsions or “oil in water” emulsions. Such systems may be those known in the metalworking art as straight oils (pure organic), soluble fluids (oil in water emulsion), semi-synthetic fluids (oil in water emulsion) and full-synthetic fluids (organic/water emulsion or solution). Exemplary nonlimiting uses of the fluids of the present invention include use as metalworking fluids, hydraulic fluids, fuels, general lubricants, and coating compositions.

Antimicrobial compositions according to the invention include one or more biocides, and a biocide enhancer consisting of one or more alkylalkanolamines according to formula (I) and one or more alkylbisalkanolamines according to formula (II):

R¹—NH—CH₂CHR³OH (I)

R²—NH(CH₂CHR⁴OH)₂ (II)

wherein R¹ and R² are each individually selected from the group consisting of branched and linear C4 to C16 alkyl groups and wherein R³ and R⁴ are each individually H or methyl. Exemplary R¹ and R² groups include 1-butyl, 2-butyl, isobutyl, 1-pentyl, 2-pentyl, 3-pentyl, isopentyl, neopentyl, 3-methylbut-2-yl, 1-hexyl, 2-hexyl, 3-hexyl, 2-methylpent-1-yl, isohexyl, 4-methylpent-2-yl, 4-methylpent-3-yl, 1-heptyl, 2-methylhex-1-yl, 5-methylhex-2-yl, 2-nonbornyl, 2-heptyl, 3-heptyl, 4-heptyl, 1-octyl, 2-octyl, 3-octyl, 4-octyl, 2-ethylhex-1-yl, nonyl, 3,5-dimethyloctyl, 3,7-dimethyloctyl, decyl, undecyl, dodecyl, tridecyl, tetradecyl, 3-methyl-10-ethyldodecyl, pentadecyl, and hexadecyl. In some embodiments, R¹ and R² are the same group. For example, both may be 1-butyl, or both may be 1-octyl. Similarly, in some embodiments R³ and R⁴ are the same; i.e., they may both be H or both methyl.

The composition of the antimicrobial composition may vary over a considerable range, as long as some amount of each of the alkylalkanolamine and alkylbisalkanolamine (the combination of which is referred to herein as the “biocide enhancer”) are present in addition to the biocide. In some embodiments of the invention, the biocide enhancer will have a composition ranging from 99 wt % alkylalkanolamine with 1 wt % alkylbisalkanolamine to 1 wt % alkylalkanolamine with 99 wt % alkylbisalkanolamine. Typically, the biocide enhancer will range from 95 wt % alkylalkanolamine with 5 wt % alkylbisalkanolamine to 5 wt % alkylalkanolamine with 95 wt % alkylbisalkanolamine. In some embodiments, the proportions will range from 70 wt % alkylalkanolamine with 30 wt % alkylbisalkanolamine to 30 wt % alkylalkanolamine with 70 wt % alkylbisalkanolamine. The exact ratio will depend upon a number of factors, including the specific choice for each of the substituents R¹-R⁴, the relative amounts and compositions of the water and organic phases (if both are present) being treated, the amount and type of biocide, and perhaps other factors. Typically, systems containing larger relative amounts of organic phase vs. aqueous (e.g., emulsion diesel fuel), and/or systems where the organic phase is a relatively hydrophobic one (e.g., paraffin oil), will usually benefit from a higher relative content of the more hydrophobic member of the biocide enhancer (usually, but not always, the alkylalkanolamine). In some embodiments, including but not limited to those in which there is more organic liquid by weight than aqueous phase, more than 50% by weight of the biocide enhancer will be the more hydrophobic component, usually the alkylalkanolamine. Conversely, systems containing larger relative amounts of aqueous phase (e.g., cutting fluid) vs. organic, and/or systems where the organic phase is a relatively hydrophilic one (e.g., high GMW polypropyleneoxide), will usually benefit from a higher relative content of the more hydrophilic member of the biocide enhancer (usually, but not always, the alkylbisalkanolamine). In some embodiments, including but not limited to those in which there is more aqueous phase by weight than organic liquid, more than 50% by weight of the biocide enhancer will be the more hydrophilic component, usually the alkylbisalkanolamine. The amount of biocide enhancer used in a composition may suitably be expressed in relation to the biocide, with the biocide typically constituting from 0.1 to 50 wt % of the combined biocide and biocide enhancer, more typically from 1 to 10 wt %. However, any ratio may be used, provided that the amount and composition of the antimicrobial composition is such that it is effective at inhibiting microbial growth.

The mixtures of alkylalkanolamines and alkylbisalkanolamines described herein for use as biocide enhancers are not intended as complete replacements for amines previously described as useful for pH adjustment in emulsion type fluid formulations, although they may in fact also serve in this capacity as well. Instead, the total amount of biocide enhancer used, and the identity and proportions of its ingredients, may be selected so as to increase the activity of a separate biocidal compound. Without wishing to be bound by any particular theory or explanation, it is believed that the high effectiveness of the present biocide enhancers in emulsion fluids and other fluids containing an aqueous phase and a liquid organic phase may result from a particularly good distribution of the components of the biocide enhancer into each of the liquid phases of the fluid. That is, the more hydrophobic compound (typically the alkylalkanolamine) may distribute preferentially into the oil phase of the emulsion while the more hydrophilic compound (typically the alkylbisalkanolamine) component distributes preferentially into the water phase. The word “typically” is used here because, depending upon the exact substituent groups R¹-R⁴, the situation may be reversed. Regardless, it is believed that a suitable distribution of the compounds of formulas (I) and (II) throughout the various parts of the fluid results in greater overall antimicrobial activity. Such emulsions may be water-in-oil emulsions, oil-in-water emulsions, or any fluid involving water and any water-immiscible liquid organic material. The pH of water-containing fluids treated with the antimicrobial compositions of this invention may have any value, but typically, the pH will be in the range of 7 to 11, and more typically in the range of 8 to 10.

It must be emphasized, however, that the compositions of this invention are also suitable for use in non-emulsion systems. For example, they may be of use in systems including water and a separate organic phase incorporating a water-immiscible liquid organic material, regardless of the amount of each and regardless of whether the system is an emulsion. The person of ordinary skill in the art will appreciate that, for example, some organic fluids (e.g., biodiesel fuels) may contain some amount of water, incorporated either purposely or by accident. Regardless of whether such fluids are properly referred to as “emulsions”, the benefits of the present invention may still be realized. In emulsion or non-emulsion formulations comprising water and an organic fluid, treated with the antimicrobial composition of this invention, wherein the organic fluid typically constitutes from 5 to 95 wt % of the composition and water typically constitutes from 95 to 5 wt % of the composition. Even further, the compositions of this invention may find utility in fluids where there is only one liquid phase, either aqueous or organic, and such use is also contemplated according to the invention.

The combined concentration of biocide and biocide enhancer may in some embodiments be as low as 250 ppm in a treated fluid (for example, a metal working fluid), and typically will be in the range of 1000 ppm to 50,000 ppm. In many cases, the concentration of the combined biocide and biocide enhancer will be from 2000 to 10,000 ppm in the treated fluid. The concentration of the biocide alone may be less than 100 ppm by weight and as low as 1 ppm in a treated fluid, and will typically be in the range of 5 ppm to 2000 ppm, depending inter alia upon on the exact composition of the biocide. The biocide enhancer concentration will typically be in the range of 100 ppm to 50,000 ppm, more typically from 500 ppm to 5000 ppm. Although the foregoing amounts and proportions are typical, much higher concentrations of biocide and biocide enhancer may be used. For example, the concentration of the total antimicrobial composition (i.e., including both biocide and biocide enhancer) may be between 1 wt % and 50 wt % in stored concentrates intended for later dilution to working concentrations.

### Biocides

Exemplary biocides include certain triazines, thiazolinones, isothiazolinones, halogenated compounds, thiocyanates, carbamates, pyrithiones, quaternary ammonium compounds, aldehydes, heterocyclic compounds, soluble metal ions and reactive alkylating agents. Specific examples of biocides include 1,3,5-(2-hydroxyethyl)-s-triazine, 2-nitro-2-bromo-1,3-propanediol, 2-methyl-5-chloro-4-isothiazolin-3-one, 2-mercaptopyridine and benzoisothiazolone. Others include phenols, morpholines, formaldehyde releasers (compounds which will hydrolyze into formaldehyde and other non-persistent fragments in aqueous solution, including, e.g., tris(hydroxymethyl)nitromethane, hexahydro-1,3,5-tris(2-hydroxyethyl)-S-triazine, hexahydro-1,3,5-triethyl-S-triazine, hexahydro-1,3,5-tris(2-hydroxyethyl)-S-triazine iodine complex, and 1-(3-chloroallyl)-3,5,7-triaza-1-azoniaadamantane chloride), azoniatricylodecanes, and oxazolidines. It is to be understood that, when the term “biocide” is used herein, its meaning does not encompass alkylalkanolamines or alkylbisalkanolamines, even though these compounds may in fact exhibit some biocidal properties on their own.

Fluids for Treatment with the Antimicrobial Compositions

In some nonlimiting embodiments of the invention, fluids suitable for treatment with the combined biocide, alkylalkanolamine, and alkylbisalkanolamines are organic liquids containing trace water (e.g., biodiesel fuel, petrodiesel fuel), oil in water emulsions (e.g., cutting fluids), water in oil emulsions (e.g., ore recovery mousse), or homogeneous solutions of organic compounds in water (e.g., hydraulic fluid). The emulsions of this invention may contain a hydrophobic oil phase, either continuous or dispersed, such as paraffin based, naphthene based or aromatic type Group I, II or III hydrocarbon refinery oils, diesters, polyol esters, synthetic hydrocarbon lubricants such as poly-alpha-olefins or poly internal olefins, polyalkyleneglycols, perfluoro compounds, alkylated phenol ethers, biodiesel fuel, seed oil derived lubricants, and/or any other hydrophobic liquids appropriate for an emulsion type fluid. Other treatable fluids include soaps and detergent fluids, cosmetics, latex paints, paper pulping fluids, drilling muds, water based hydraulic fluids, water for coolant towers, and cutting fluids.

Any fluid to be treated with the antimicrobial composition may simply be mixed with the biocide, the alkylalkanolamine, and the alkylbisalkanolamine in any order, either separately or in any combination, without any particular processing steps other than simple mixing and agitation. No heating or other special conditions are required, and in fact it is desirable in some embodiments to avoid higher temperatures so as to prevent reaction or decomposition of the components of the composition.

### EXAMPLES

The following data provide an indication of the high level of effectiveness of compositions and methods according to the invention.

### Comparative Example 1

### Single Amines in Combination with a Biocide

A kinetic assay of bacterial growth in a 384 well microtiter plate was monitored by absorbance at 660 nm. The bacteria was Pseudomonas aerguinosa (ATCC 27853). The organism was grown overnight in Trypticase Soy Broth (TSB), pelleted, and resuspended in new medium at half its original density. The final inoculum was determined from plate counts on Trypticase Soy Agar (TSA) plates spread at the time of use as 4.5×10E10 CFU/mL. Each well of the microtiter plate (well volume=75 μL) was filled with 25 μL of a buffered aqueous solution of the amine being tested at the concentration necessary to yield the desired test concentration after dilution, enough Tris buffer to keep the well pH at 8.5, 25 μL of a biocide solution, and 25 μL reconstituted bacterial culture. The biocide solution and bacterial inoculum were mixed with TSB nutrient. The biocide utilized was KATHON 886MW (supplied by Rohm & Haas Company, Springhouse, Pa.). KATHON 886 MW is a 15% active solution of ⅔ CMIT (5-chloro-2-methyl-4-isothiazolin-3-one) and ⅓ MIT (2-methyl-4-isothiazolin-3-one). The experimental assessment of bacterial growth was made through an end-point absorbance measurement taken after 48 hours of growth in the various media. The concentration of the 4 different amines was 400 ppm. The concentration of the biocide was an experimental variable. The amines employed in this experiment were decyloxypropylaminopropylamine (DOPAPA), octylaminoethanol (OAE, a compound according to formula I), octyldiethanolamine (ODEA, a compound according to formula II), and dicyclohexylamine (DCHA). All absorbance values are the averages of at least three replicates. The end-point absorbances (660 nm), which are directly proportional to bacterial concentration, are presented in Table 1 below.

TABLE 1

| KATHON 886MW | | | | | |
|---|---|---|---|---|---|
| Loading | | DOPAPA | OAE | ODEA | DCHA |
| 0 | ppm | app. 0.3 | 0 | 0.12 | 0.14 |
| 12 | ppm | app. 0.3 | 0 | 0.08 | 0.14 |
| 25 | ppm | app. 0.3 | 0 | 0.08 | 0.10 |
| 50 | ppm | app. 0.3 | 0 | 0.03 | 0.07 |

Note that 50 ppm of KATHON 886MW is below the minimum inhibitory concentration (MIC) oftentimes reported in the literature for use of this biocide alone with this species of bacteria. Thus, DOPAPA was weak or ineffective as an enhancer for the biocide under these conditions. DCHA was a marginal enhancer, ODEA was a moderately effective enhancer, and OAE was an excellent enhancer. However, both DCHA and OAE are more toxic to humans than ODEA, thus limiting their applicability in some situations. Unfortunately, ODEA was less effective as an enhancer than OAE.

### Example 1

### Amine Pairs in Combination with a Biocide

A kinetic assay was run via absorbance measurements in a 384 well micro-titer plate with 75 μL) plate volume. Pseudomonas aerguinosa (ATCC 15442) was used as the inoculum for this kinetic assay. The organism was grown overnight in Trypticase Soy broth, pelleted, and resuspended in new medium at half its original density. The final inoculum was determined from plate counts on TSA plates spread at the time of use as 8.0×10E10 CFU/mL Each well of the microtiter plate (well volume=75 μL) was filled with 25 μL of a buffered aqueous solution of the amine being tested at the concentration necessary to yield the desired test concentration after dilution, enough Tris buffer to keep the well pH at 8.5, 25 μL of a biocide solution, and 25 μL reconstituted bacterial culture. The pH was adjusted to 8.5 with the buffer. The biocide was KATHON 886MW. The following amines were tested: butylaminoethanol (BAE, a compound according to formula I), butyldiethanolamine (BDEA, a compound according to formula II), octylaminoethanol (OAE, a compound according to formula I), and octyldiethanolamine (ODEA, a compound according to formula II), all at 99% purity):

| | | |
|---|---|---|
| Row A: | 0 | ppm |
| Row B: | 12.5 | ppm |
| Row C: | 25 | ppm |
| Row D: | 50 | ppm |
| Row G: | 100 | ppm |
| Row H: | 200 | ppm |
| Row I: | 0 | ppm |
| Row J: | 12.5 | ppm |
| Row K: | 25 | ppm |
| Row L: | 50 | ppm |
| Row M: | 100 | ppm |
| Row N: | 200 | ppm |
| Row O: | 0 | ppm |

| | |
|---|---|
| Row P | Plate Blank: water only in columns 1-4, positive |
| | growth control in columns 5-24 |

(Rows E & F were not used.)

The columns were laid out as follows:

For Rows A-H:

| Columns 1-4: | BAE | 1,000 | ppm |
|---|---|---|---|
| Columns 5-8: | BDEA | 1,000 | ppm |
| Columns 9-12: | BAE/BDEA | 500 ppm/500 ppm | |
| Columns 13-16: | OAE | 250 | ppm |
| Columns 17-20: | ODEA | 250 | ppm |

| | | |
|---|---|---|
| Columns 21-24: | OAE/ODEA | 125 ppm/125 ppm |

For Rows I-O:

| Columns 1-4: | BAE | 2,000 | ppm |
|---|---|---|---|
| Columns 5-8: | BDEA | 2,000 | ppm |
| Columns 9-12 | BAE/BDEA | 1000 ppm/1000 ppm | |
| Columns 13-16: | OAE | 500 | ppm |
| Columns 17-20: | ODEA | 500 | ppm |

| | | |
|---|---|---|
| Columns 21-24: | OAE/ODEA | 250 ppm/250 ppm |

For Row P: no amine

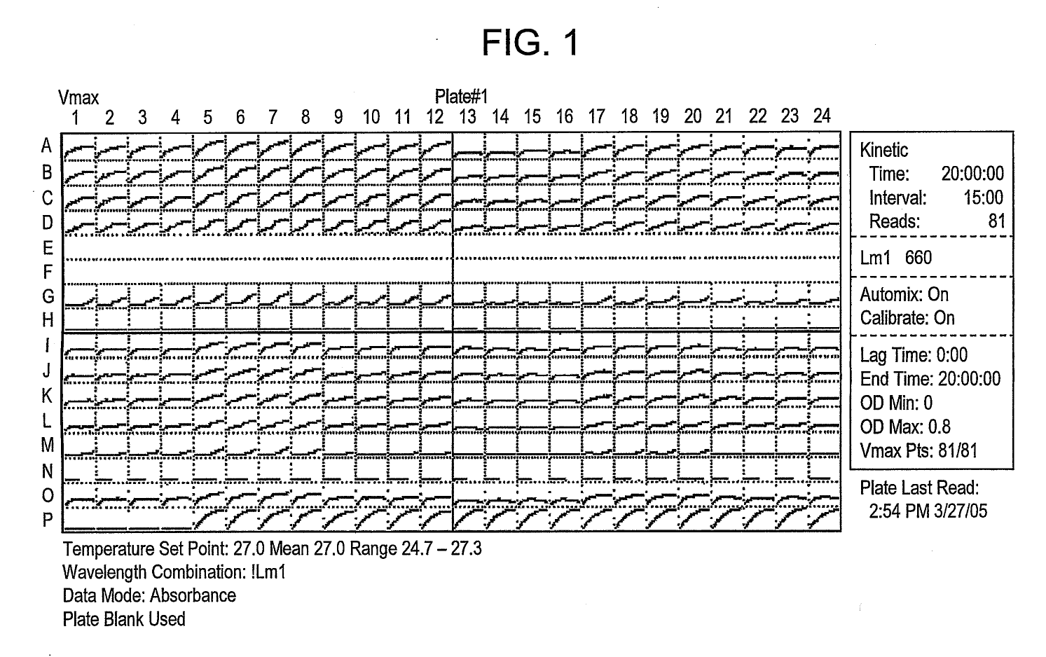

The experiment ran for 20 hours with absorbance measurements taken once every 15 minutes. The data was processed by taking 10 point maximum growth slopes (milliOD per minute) after a 3 hour delay. The results of the above series are shown in FIG. 1, and selected data are tabulated in Table 2, in which biocide (KATHON) was used at a 100 ppm level.

TABLE 2

| | | Maximum Growth |
|---|---|---|
| Run | Amine (Concentration) | Slope (MilliOD/min) |
| 1 | BAE (2000 ppm) | 0.4 |
| 2 | BDEA (2000 ppm) | 0.8 |
| 3 | BAE/BDEA (1000 ppm each) | 0.4 |
| 4 | BAE (1000 ppm) | 0.9 |
| 5 | BDEA (1000 ppm) | 1.3 |
| 6 | OAE (500 ppm) | −0.1 |
| 7 | ODEA (500 ppm) | 0.4 |
| 8 | OAE/ODEA (250 ppm each) | −0.1 |
| 9 | OAE (250 ppm) | 0.4 |
| 10 | ODEA (250 ppm) | 0.6 |

Comparison of runs 1-5 shows that BAE alone was more effective than BDEA alone, but that a combination of BAE and BDEA was equal in effectiveness to BAE alone. An advantage may be obtained in using such a combination, because BDEA has lower human toxicity than BAE. Similarly, comparison of runs 6-10 shows that a combination of ODEA with OAE was as effective as OAE alone, despite the lower activity of ODEA by itself. Both of the combinations shown in Table 2 are examples of how the present invention may provide equal antimicrobial activity with reduced human toxicity. Alternatively, it may also be possible to provide a higher level of antimicrobial activity at a given level of human toxicity using the methods and compositions of the invention.

Although the invention is illustrated and described herein with reference to specific embodiments, it is not intended that the subjoined claims be limited to the details shown. Rather, it is expected that various modifications may be made in these details by those skilled in the art, which modifications may still be within the spirit and scope of the claimed subject matter and it is intended that these claims be construed accordingly.

1. A composition comprising an effective amount of a biocide and a biocide enhancer, said enhancer consisting of one or more compounds according to formula (I) and one or more compounds according to formula (II):
R¹—NH—CH₂CHR³OH (I)
R²—NH(CH₂CHR⁴OH)₂ (II)
wherein R¹ and R² are each individually selected from the group consisting of branched and linear C4 to C16 alkyl groups and wherein R³ and R⁴ are each individually H or methyl.

2. The composition of claim 1, wherein the one or more compounds according to formula (I) and the one or more compounds according to formula (II) comprise compounds in which R¹ and R² are the same.

3. The composition of claim 1, wherein the one or more compounds according to formula (I) and the one or more compounds according to formula (II) comprise compounds in which R¹ and R² are both 1-butyl.

4. The composition of claim 1, wherein the one or more compounds according to formula (I) and the one or more compounds according to formula (II) comprise compounds in which R¹ and R² are both 1-octyl.

5. The composition of claim 1, wherein the one or more compounds according to formula (I) and the one or more compounds according to formula (II) comprise compounds in which R³ and R⁴ are the same.

6. The composition of any claim 1, wherein the one or more compounds according to formula (I) and the one or more compounds according to formula (II) comprise compounds in which R³ and R⁴ are both hydrogen.

7. The composition of claim 1, wherein the one or more compounds according to formula (I) constitute from 5 to 95 wt % of the biocide enhancer and the one or more compounds according to formula (II) correspondingly constitute from 95 to 5 wt % of the biocide enhancer.

8. The composition of claim 1, wherein the biocide comprises an isothiazolinone.

9. The composition of claim 1, wherein the biocide enhancer and the biocide together constitute a first component, the composition further comprising a second component, said second component comprising a water-immiscible liquid organic material.

10. The composition of claim 9, wherein the composition further comprises water.

11. The composition of claim 9, wherein the liquid organic material is selected from the group consisting of hydrocarbon refinery oils, esters, synthetic hydrocarbon lubricants, polyalkyleneglycols, perfluoro compounds, alkylated phenol ethers, and biodiesel oils.

12. The composition of claim 9, wherein the composition comprises a water-in-oil emulsion or an oil-in-water emulsion.

13. The composition of claim 9, wherein the second component constitutes from 5 to 95 wt % of the composition and water constitutes from 95 to 5 wt % of the composition.

14. The composition of claim 9, wherein the composition is a metalworking fluid.

15. The composition of claim 9, wherein the pH of the composition is from 7 to 11.

16. The composition of claim 9, wherein the pH of the composition is from 8 to 10.

17. The composition of claim 9, wherein the biocide enhancer constitutes from 100 to 50,000 ppm by weight of the composition.

18. The composition of claim 9, wherein the biocide constitutes less than 100 ppm by weight of the composition.

19. A method of inhibiting or preventing biological growth in a composition, the method comprising adding to the composition an effective amount of a biocide and a biocide enhancer, said enhancer consisting of one or more compounds according to formula (I) and one or more compounds according to formula (II):
R¹—NH—CH₂CHR³OH (I)
R²—NH(CH₂CHR⁴OH)₂ (II)
wherein the one or more compounds according to formula (I) constitute from 5 to 95 wt % of the biocide enhancer and the one or more compounds according to formula (II) correspondingly constitute from 95 to 5 wt % of the biocide enhancer; wherein R¹ and R² are each individually selected from the group consisting of branched and linear C4 to C16 alkyl groups and wherein R³ and R⁴ are each individually H or methyl.

20. The method of claim 19, wherein the one or more compounds according to formula (I) and the one or more compounds according to formula (II) comprise compounds in which R¹ and R² are the same.

21. The method of claim 19, wherein the one or more compounds according to formula (I) and the one or more compounds according to formula (II) comprise compounds in which R³ and R⁴ are both hydrogen.

22. The method of claim 19, wherein the composition comprises water and a water-immiscible liquid organic material.

23. The method of claim 19, wherein the composition is a metalworking fluid.

24. The method of claim 22, wherein the composition comprises more liquid organic material by weight than water, and wherein the one or more compounds of formula (I) constitute more than 50% by weight of the biocide enhancer.

25. The method of claim 22, wherein the composition comprises more water organic by weight than liquid organic material, and wherein the one or more compounds of formula (II) constitute more than 50% by weight of the biocide enhancer.
